(19) United States
(12) Patent Application Publication
(10) Pub. No.: US 2008/0168855 A1
(43) Pub. Date: Jul. 17, 2008

(54) Adjusting Device, In Particular For the Adjustable Base of a Household Device

(75) Inventors: Heinz-Werner Giefer, Sontheim (DE); Anton Oppel, Syrgenstein (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/665,504

(22) PCT Filed: Oct. 12, 2005
(86) PCT No.: PCT/EP2005/055192

§ 371 Date: Apr. 13, 2007

(30) Foreign Application Priority Data
Oct. 15, 2004 (DE) 10 2004 050 362.1

(51) Int. Cl. F16H 1/12; F16M 11/20

(52) U.S. Cl. 74/412 R; 248/188.4

(57) ABSTRACT

An adjusting device, in particular for the adjustable base of a household device, is provided and includes a threaded rod or bolt which is mounted in an adjustable housing and which can be displaced in an axial manner. The threaded rod or bolt is configured in such a manner that it can be connected to a threaded drive member which is rotationally mounted in the adjustable housing, such that the threaded bolt or rod can be directly rotated by means of the rotative movement of the threaded drive member.

The invention relates to an adjusting device, in particular for the adjustable base of an object, consisting of a threaded rod or bolt that is mounted in an adjustable housing and is axially displaceable. The invention further relates to a household device with an adjusting device of the above-mentioned type.

In the case of household devices a method has long been known, for example, to provide them with adjustable bases, at least one of which is height adjustable for adapting the household device to be installed to the local conditions. To make it easier for the user to adjust the height of the adjustable bases, a multiplicity of different solutions is known from the state of the art.

DE 196 06 460 A1 discloses a height adjusting device for an adjustable base from a vertical threaded rod, with a base plate, guided in a fixed adjustable housing, a nut rotationally mounted in the adjustable housing being screwed by means of the threaded rod, which nut is designed on its outer circumference as a worm wheel and is driven by a screw connected to an adjustable rod rotatably mounted in the adjustable housing. Here the threaded rod of the adjustable base in the adjustable housing is positively guided. Because of the positive guidance of the threaded rod of the adjustable base, the adjustable base is not also rotated when the height adjusting device is actuated. The clamping connection is achieved by a providing a flattened section along the thread or by at least one axially running groove, the flattened section bearing against the adjustable housing at least one point, and the adjustable housing engaging in the axially running groove. By the use of a gear the arrangement described suffers from the disadvantage that a relatively large adjustable housing is required because of the gear.

A similar arrangement is described in DE 94 21 684 U1.

An arrangement similar to that disclosed in DE 196 06 460 A1 is also described in DE 295 12 662 U1, in which the screw is also provided with a friction clutch to avoid damage to the gear.

A further household device with vertically adjustable support feet is disclosed in DE 33 36 375 C2. The support feet consist of a threaded rod, with a base plate, mounted in the device base so that it can be screwed. Furthermore, a device designed as a gear is provided for adjusting the rear device support feed by means of an adjusting bar from the front side of the household device. The base plate fixedly connected to the threaded rod is designed as a worm wheel in which a worm shaft engages. The worm shaft forms part of the adjusting rod and is produced from wire by winding in coil fashion. In principle the loading capacity of such a design is low.

In the household device described in DE-GM 74 35 483 the gear for adjusting the support foot is arranged inside the device housing, for which purpose the support foot or its extended threaded rod is connected positively, inside the device housing, to a worm wheel as part of the gear. The support foot can be moved vertically with an adjusting device guided to the front side of the device in the form of an adjusting bar. For this purpose the adjusting rod supports a screw which engages with the worm wheel. In the region of the front side of the machine the adjusting bar is mounted in a rubber element which is inserted in an opening of the housing plate of the machine the support foot, with the threaded rod mounted in the housing base so that it can be screwed, is provided underneath with a rubber coating, the end on the base side being rotationally mounted in the base plate. The disadvantage of this arrangement is that all the parts belonging to the gear are arranged inside the device housing in regions which are of difficult access, both from the production point of view and for maintenance purposes, so that a gear arranged in this manner negatively influences the costs of production.

Finally, U.S. Pat. No. 1,632,383 discloses a method for using a bevel gear, installed in the table leg, for adjusting the height of a table leg.

The object of the invention is therefore to provide, in a simple manner, a height adjusting device, in particular for an adjustable base of an object such as a household device or piece of furniture, as well as in other areas, e.g. in motor manufacture, which device, simply constructed, guarantees high stability and can be produced inexpensively.

Furthermore, a household device will be indicated in which at least individual adjustable bases can be adjusted in their height as simply and as inexpensively as possible.

These objects are achieved with an adjusting device with the features of Claim 1 and with a household device with the features of Claim 13. Advantageous designs are evident from each of the dependent claims.

According to the invention the threaded rod or bolt is designed so that it can be brought into engagement with a screw rotationally mounted in the adjustable housing in such a manner that the threaded rod or bolt can be rotated directly by a rotative movement of the screw. Consequently a gear is advantageously provided which has fewer components than the devices of prior art, as a result of which the adjusting device generally requires less space. This is achieved, in particular, in that the screw and the threaded rod or bolt engage directly. This is made possible by the fact that the threaded rod or bolt is rotationally mounted relative to the adjustable housing. The threaded rod is then rotated by the screw connected to the threaded rod or bolt so that it can be adjusted axially in the desired direction.

In order also to be able to adjust the threaded rod or bolt in its axial direction in its direction from the front side of an object to be adjusted, it is advantageous, according to the invention, for the axes of the screw and the threaded rod or bolt to intersect at an angle, preferably a 90° angle.

To ensure that the threaded rod or bolt is rotated by a screw which engages directly with the threaded rod or bolt, provision is made, according to the invention, to superimpose upon the thread of the threaded rod or bolt toothing to enable the screw to engage directly in the threaded rod or bolt.

The toothing may be formed by a plurality of grooves inserted in the threaded rod or bolt, which grooves extend so that they run essentially parallel to each other. In order words, it is possible to dispense with a further worm wheel, which, when actuated, brings about an axial adjustment of the threaded shaft or bolt in the state of the art, because a further toothing is superimposed on the thread of the threaded rod, which toughing is designed so that it is adapted to the screw thread of the screw. Here the grooves preferably run helically, an acute angle to the axis of the threaded rod or bolt being formed.

The adjustable housing preferably projects from the threaded rod or bolt so that the thread of the threaded rod or bolt engages in a suitable thread of a bore in the adjustable housing.

Expressed in other terms, this means that the adjustable housing itself has a thread, so that the threaded rod or bolt can be rotated into it with its thread. The adjustable housing may also have a separate component which is connected positively to it, which component is then provided with a thread into which the threaded rod or bolt can be rotated. The adjustable housing may also formed by part of the object to be adjusted itself.

According to a further advantageous design the screw of a bushing of the adjustable housing is rotationally mounted. Here it is particularly preferable for the bushing to be arranged in the adjustable housing so that it is positively releasable. This procedure enables a screw to be provided in or omitted from the adjusting device in its production. Because the threaded rod or bolt is rotationally mounted in a thread of the adjusting device, it is also possible to adjust the object by directly twisting the threaded rod or bolt. A more convenient adjusting facility is provided when the threaded rod or bolt can be axially displaced by means of the screw then provided in the adjusting device. The preferred adjusting device, with the screw, may, for example, be reserved for objects in a higher price category during production, whilst objects in a lower price category can only be adjusted by direct twisting of the threaded rod or bolt, since the screw has been omitted from it.

In a further suitable design the screw is provided with 1 or 2 turns. The choice of how many turns with which the screw thread is to be provided depends on the angle of distortion of the screw at which and which axial path of the threaded rod or bolt is to be actuated, or on the forces that may act on the toothing on the threaded rod or bolt without the latter being damaged in use. The appropriate choice ultimately depends on the object to be adjusted by means of the adjusting device according to the invention.

The threaded rod or bolt and/or the screw may be produced either from a plastic, in particular by means of an injection moulding process, or from a metal. The threaded rod may preferably be designed in one or several parts, in particular in two parts, from a tubular element and a threaded bar. Here the use of metal enables extremely long-lived adjusting devices to be produced since even frequent actuation will not result in appreciable wear.

It is also preferable for the adjusting device to represent a height adjusting device for an adjustable base of a household, e.g. a cooking range, a washing machine, a dryer or a dishwasher, and for the threaded rod or bolt to be provided at a base-side end with a plate.

To prevent the base from being damaged by the rotation of the threaded rod or bolt and the plate connected to it, the threaded rod or bolt and the plate are connected torsionally to each other according to a further preferred design.

A household device according of the above-mentioned type, according to the invention, is characterised in that it has at least one adjusting device according to one of the designs described above.

According to an advantageous embodiment of the invention the household device is equipped with at least two adjustable bases, two adjustable bases being arranged on the front side of the household device, and one adjustable base being arranged on the rear side of the household device, and the adjustable base arranged on the rear side being adjustable in height with the adjusting device from a lateral wall of the household device. The expenditure relating to a household device, and hence the costs, are reduced by the arrangement of only one adjustable base with an adjusting device that can be operated from one lateral housing wall.

According to a preferred embodiment of the invention the adjustable base arranged on the rear side of the household device is arranged approximately in the centre of the lower rear housing edge of the household device. By arranging the adjustable base arranged on the rear side approximately in the centre of the lower rear housing edge, it is able to bear against the contour of an approximately isosceles triangle, which represents the most stable form of contact of a three-point support.

Advantageously at least the adjusting device of the adjustable base arranged on the rear side has the screw which engages in the threaded rod or bolt and which can be actuated by an adjusting rod that is in operative connection with it, is rotationally housed in the household device and can be operated from the front side of the household device.

In order to expand the adjustment possibilities at least one of the adjustable bases arranged on the front side of the household device is adjustable in height according to a further advantageous embodiment of the invention.

The invention is explained below with reference to the exemplary embodiment represented in the drawing, in which:

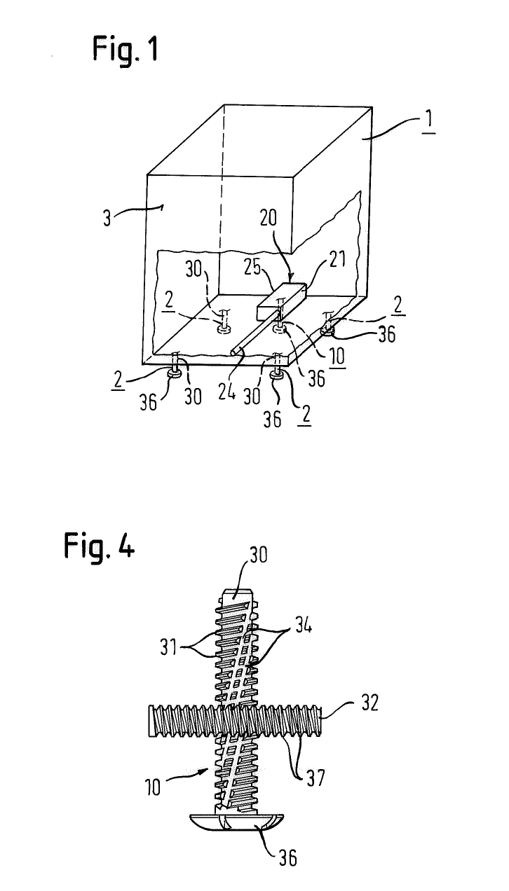

FIG. 1 shows a diagrammatically represented household device with an adjusting device according to the invention for an adjustable base shown in a perspective representation,

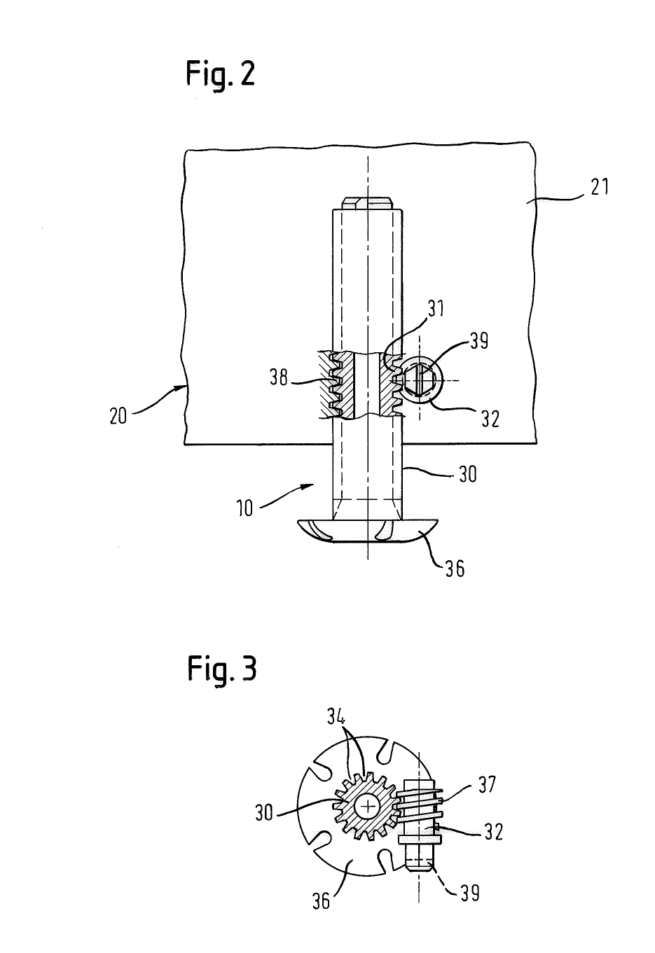

FIG. 2 shows a lateral representation of a section through an adjusting device according to the invention for an adjustable base,

FIG. 3 shows an elevation of the adjusting device according to the invention, which is represented in FIG. 2, and

FIG. 4 shows a further representation of the threaded rod or bolt, which shows a clearer view of the superposition of a toothing.

A housing 1 of a household device not explained in greater detail is equipped, in the exemplary embodiment shown, with five adjustable bases 2, 10, which are adjustable in height. Four adjustable bases 2 are each arranged in the region of the outer, lower housing edges. These adjustable bases 2 are screwed by a known method, by means of their threaded bolt, into a female thread, not described in further detail, of an adjusting housing of the adjusting device and are adjustable in height by manually screwing in and/or out.

Fifth adjustable base 10 is arranged approximately in the centre of the lower rear housing edge and is adjustable in height by means of an adjusting device 20 according to the invention, from the front side 3 of the household device in the exemplary embodiment shown, this adjustable base 10 consists of a threaded rod or bolt which is also screwed into a female thread not shown in this figure, and of a plate 36 that can be rotated relative to the threaded rod or bolt.

Threaded rod 30 may, in both variants, be guided vertically in a fixed adjustable housing 21 of adjusting device 20. Although adjustable housing 21 is only represented in the case of the fifth adjustable base 1, this housing could, in principle, be used for any of adjustable bases 2, 10. In the case of the adjustable bases denoted by reference number 2, the insertion of a screw in the adjustable housing is dispensed with, for example, so that a height adjustment of these adjustable bases 2 can only be distorted by the direct rotation of the threaded rod or bolt or, if the plate is connected fixedly to the threaded rod, by the direct rotation of the plate. On the other hand, the height adjustment of adjustable base 10 is carried out using a screw 32 (not shown in FIG. 1), which can be actuated by an adjusting bar 24 from the front side 3 of the device.

The structure of the adjusting device according to the invention is shown more clearly in FIGS. 2 to 4.

FIG. 2 shows, in a sectional representation, a side view of adjusting device 20 according to the invention. Threaded rod 30 is screwed into an adjustable housing 21, not described in greater detail, which is provided with a female thread 38. Screw 32, which is shown in the representation in FIG. 2, in elevation, engages directly with threaded rod 30. The axes of screw 32 and threaded rod 30 preferably run at an angle of 90° to each other, an oblique position at any angle also being possible. Screw 32 is adjusted, for example, by a slot 39 into which a screwdriver can be inserted from one side of the housing.

The elevation in FIG. 3 shows more clearly how screw 32 provided with a thread 37 engages directly with threaded rod 20. A toothing, in the form of grooves 34 running parallel to each other and extending helically in the axial direction, is superimposed upon threaded rod 30. Thread 37 of screw 32, and the distance between and size of grooves 34, are dimensioned so that the threaded rod can be twisted by rotating the screw. The representation in FIG. 4 shows this relationship once again more clearly, and in this case the threaded rod or bolt is only provided with the grooves in a circumferential section for the purpose of greater clarity. In practice the grooves extend throughout the circumference of the threaded rod or bolt.

In a further embodiment, not shown, the threaded rod 30 may also be constructed of two parts. Threaded rod 30 consists of a tubular element with thread 31 on the outside, and a corresponding plate on the lower side. A preferably fixed threaded bar is located in the cylindrical cavity of the tubular element. The rotative movement is therefore preferably only performed by the tubular element. The household device is secured to the threaded bar.

To effect a height adjustment of an adjustable base screw 32 is not absolutely necessary because an adjustment in the axial direction is possible by direct rotation on threaded rod 30. Screw 32 is therefore preferably mounted in a bushing (not shown), which allows the optional provision of the adjusting device. This enables the adjusting device according to the invention to be used to form a “simple” adjustable base 2 or a “convenient” adjustable base 10.

By superimposing the toothing in the male thread of threaded rod 30 it is advantageously possible to dispense with the worm wheel of prior art, which causes the screw to rotate in an axial feed direction of the threaded rod.

### LIST OF REFERENCE NUMBERS

1 Housing
2 Adjustable base
3 Front side
10 Adjustable base
20 Adjusting device
21 Adjustable housing
24 Adjusting bar
25 Outlet openings
30 Threaded rod or bolt
31 Thread
32 Screw
33 Bearing
34 Groove
35 Bushing
36 Plate
37 Thread
38 Thread
39 Slot

1-17. (canceled)

18. An adjusting device, particularly for an adjustable base of an object, the adjusting device comprising:
a threaded elongate element having a longitudinal axis, the threaded elongage element being mountable in an adjustable housing and being longitudinally axially displaceable relative to the adjustable housing and the threaded elongate element being configured such that it can be brought into engagement with a threaded drive member rotationally mounted in the adjustable housing in a manner such that the the threaded elongate element is rotated directly by a rotative movement of the threaded drive member.

19. The adjusting device according to claim 18, wherein the threaded drive member and the threaded elongate element engage directly with each other.

20. The adjusting device according to claim 18, wherein the axes of threaded drive member and the threaded elongate element intersect at an angle.

21. The adjusting device according to claim 18, wherein the thread of the threaded elongate element has a toothing is superimposed thereon to allow engagement of the threaded drive member.

22. The adjusting device according to claim 21, wherein the toothing is formed by a plurality of grooves inserted in the threaded elongate element, which grooves extend essentially parallel to each other.

23. The adjusting device according to claim 18, wherein the adjustable housing projects from the threaded elongate element according to claim 18, wherein so that the thread of the threaded elongate element engages in a corresponding thread of a bore in the adjustable housing.

24. The adjusting device according to claim 18, wherein the threaded drive member is rotationally mounted in a bushing of the adjustable housing.

25. The adjusting device according to claim 24, wherein the bushing is arranged so that it is positively clamped and is releasable in the adjustable housing.

26. The adjusting device according to claim 18, wherein the threaded drive member is designed with a selected one of one turn and two turns.

27. The adjusting device according to claim 18, wherein at least one of the threaded elongate element and the threaded drive member is produced from a selected one of a plastic and metal, wherein the threaded rod is formed preferably in one section or several sections, in particular two sections, from a tubular element or a threaded bar.

28. The adjusting device according to claim 18, wherein the adjusting device represents a height adjusting device for an adjustable base of a household device and the threaded elongate element is provided at a base-side end therof with a plate.

29. The adjusting device according to claim 28, wherein the threaded elongate element and the plate are connected torsionally to each other.

30. A household device, comprising:
an operating portion;
a base on which the operating portion is supported;
an adjustable housing operatively connected to the base for adjusting a spacing of the base from a selected surface; and
an adjusting device having a threaded elongate element with a longitudinal axis, the threaded elongage element being mountable in the adjustable housing and being longitudinally axially displaceable relative to the adjustable housing and the threaded elongate element being configured such that it can be brought into engagement with a threaded drive member rotationally mounted in the adjustable housing in a manner such that the the threaded elongate element is rotated directly by a rotative movement of the threaded drive member.

31. The household device according to claim 30 and further comprising at least three adjustable bases, wherein two adjustable bases are arranged on afront side of the household device and one adjustable base is arranged on a rear side of the household device, and wherein the base arranged on the rear side is adjustable in height with the adjusting device from a lateral wall of the household device.

32. The household device according to claim 31, wherein at least the adjusting device of the adjustable base arranged on the rear side has the threaded drive member engaging in the threaded elongate element, which threaded drive member can be actuated by an adjusting bar that is operatively connected to it, is mounted rotationally in the household device, and can be operated from the front side of the household device.

33. The household device according to claim 31, wherein at least one of the adjustable bases arranged on the front side of the household device is adjustable in height.

34. The household device according to claim 31, wherein the adjustable base arranged on the rear side of the household device is arranged approximately in the center of a lower rear housing edge of the household device.
